(19) United States
(12) Patent Application Publication
(10) Pub. No.: US 2025/0047421 A1
(43) Pub. Date: Feb. 6, 2025

(54) HARQ OPERATION METHOD OF TERMINAL IN WIRELESS COMMUNICATION SYSTEM, AND APPARATUS USING METHOD

(71) Applicant: LG Electronics Inc., Seoul (KR)

(72) Inventors: Jongku LEE, Seoul (KR); Sunam KIM, Seoul (KR); Sungryong HONG, Seoul (KR); Dongsun LEE, Seoul (KR)

(21) Appl. No.: 18/692,951

(22) PCT Filed: Sep. 16, 2021
(86) PCT No.: PCT/KR2021/012678

§ 371 Date: Oct. 9, 2024

(51) Int. Cl. H04L 1/1822; H04L 1/1829; H04W 72/232

(52) U.S. Cl. CPC H04L 1/1822; H04L 1/1854; H04W 72/232

(57) ABSTRACT

A HARQ operation method of a UE in a wireless communication system, and an apparatus using the method are provided. The method comprises receiving one piece of DCI related to scheduling of a plurality of data channels, and receiving or transmitting at least one from the plurality of data channels based on the DCI. Each of the plurality of data channels is related to a different HARQ process number in an ascending order, the DCI includes information informing of the at least one data channel based on the HARQ process numbers, and the information includes i) a start HARQ process number from among HARQ process numbers related to the at least one data channel, and ii) a discontinuous HARQ process indicator (DHPI) informing whether each of HARQ process numbers next to the start HARQ process number from among the HARQ process numbers is used.

### TECHNICAL FIELD

This disclosure relates to a HARQ operation method in a wireless communication system and a device using the method.

### BACKGROUND ART

3rd Generation Partnership Project (3GPP) Long-Term Evolution (LTE) is a technology to enable high-speed packet communication. Many methods have been proposed to achieve the LTE goals of reducing costs for users and operators, improving service quality, expanding coverage, and increasing system capacity. 3GPP LTE requires lower cost per bit, improved service usability, flexible use of frequency bands, simple structure, open interface, and appropriate power consumption of the user equipment (UE) as high-level requirements.

Work has begun at the International Telecommunication Union (ITU) and 3GPP to develop requirements and specifications for New Radio (NR) systems. 3GPP needs to identify and develop the technical components required to successfully standardize NR that satisfies both urgent market needs and the longer-term requirements set out by the ITU Radio Communication Sector (ITU-R) International Mobile Telecommunications (IMT)-2020 process in a timely manner. Additionally, NR should be able to use any spectrum band up to at least 100 GHz, which can be used for wireless communications even in the distant future.

NR targets a single technology framework that covers all deployment scenarios, usage scenarios, and requirements, including enhanced Mobile BroadBand (eMBB), massive Machine Type-Communications (mMTC), Ultra-Reliable and Low Latency Communications (URLLC), and more. NR should be inherently forward compatible.

With the commercialization of NR, which is the 5th generation (5G) mobile communication technology, research on the 6th generation (6G) mobile communication technology is beginning. The 6th generation mobile communication technology is expected to utilize a frequency band of 100 GHz or higher. Accordingly, it is expected that the available frequency can be increased by more than 10 times compared to 5G, and the possibility of utilizing space resources can be further increased. This frequency band above 100 GHz may be referred to as sub-terahertz (sub-THz).

Meanwhile, the rapid growth of data traffic in wireless communication systems has led to the development of technologies to transmit data over unlicensed spectrum bands. Because unlicensed bands can share frequencies with other communications systems, such as Wi-Fi, it may be necessary to design channel access schemes that allow multiple wireless access technologies to coexist. For example, unlicensed bands may be designed to use a channel access scheme based on energy detection operation.

For example, LTE-LAA (Licensed Assisted Access) and NR-U (New Radio Unlicensed) support Listen Before Talk (LBT) technology, which enables frequency sharing between multiple radio access technologies under the Carrier Sensing Multiple Access/Collision Avoidance (CSMA/CA) procedure.

Transmitting data in unlicensed bands may always involve LBT operation. Therefore, the typical transmission method of scheduling one uplink data channel (e.g., physical uplink shared channel (PUSCH)) via one downlink control information (DCI) may result in a significant degradation of the uplink data rate. Therefore, LTE-eLAA (enhanced LAA) and NR-U introduce multi-TTI scheduling technology that allows multiple PUSCHs to be scheduled through a single DCI.

Conventional multiple TTI scheduling techniques are designed so that the HARQ process numbers of multiple physical shared channels (such as PDSCH or PUSCH, hereafter referred to as PXSCH) scheduled through a single DCI have consecutive values. This was to prevent the number of bits in DCI from increasing to convey the HARQ process number. However, in real-world wireless communication situations, the continuity of HARQ process numbers can be difficult to maintain, and the prior art does not provide a solution to this problem.

### DISCLOSURE

### Technical Problem

The present disclosure provides a method for operating a HARQ of a UE in a wireless communication system and an apparatus using the method.

### Technical Solution

In one aspect, provided is a method of performing a hybrid automatic repeat and request (HARQ) operation of a user equipment (UE) in a wireless communication system. The method includes receiving one downlink control information (DCI) related with scheduling of a plurality of data channels, and receiving or transmitting at least one data channel of the plurality of data channels based on the DCI. Each of the plurality of data channels is related with a different HARQ process number in ascending order. The DCI comprises information informing the at least one data channel based on a HARQ process number. The information comprises: i) a starting HARQ process number among HARQ process numbers related with the at least one data channel, and ii) a Discontinuous HARQ Process Indicator (DHPI) informing whether each HARQ process number following the starting HARQ process number among the HARQ process numbers is used.

In another aspect, provided is a user equipment (UE) performing hybrid automatic repeat and request (HARQ) operation in a wireless communication system. The UE includes at least one transceiver, at least one memory and at least one processor operably coupled to the at least one memory. The at least one processor is adapted to: receive one downlink control information (DCI) related with scheduling of a plurality of data channels and receive or transmitting at least one data channel of the plurality of data channels based on the DCI. Each of the plurality of data channels is related with a different HARQ process number in ascending order. The DCI comprises information informing the at least one data channel based on a HARQ process number. The information comprises: i) a starting HARQ process number among HARQ process numbers related with the at least one data channel, and ii) a Discontinuous HARQ Process Indicator (DHPI) informing whether each HARQ process number following the starting HARQ process number among the HARQ process numbers is used.

In still another aspect, provided is an apparatus performing hybrid automatic repeat and request (HARQ) operation in a wireless communication system. The apparatus includes at least one processor, and at least one memory operably coupled to the at least one processor, wherein the at least one processor is adapted to: receive one downlink control information (DCI) related with scheduling of a plurality of data channels, and receive or transmitting at least one data channel of the plurality of data channels based on the DCI. Each of the plurality of data channels is related with a different HARQ process number in ascending order. The DCI comprises information informing the at least one data channel based on a HARQ process number. The information comprises: i) a starting HARQ process number among HARQ process numbers related with the at least one data channel, and ii) a Discontinuous HARQ Process Indicator (DHPI) informing whether each HARQ process number following the starting HARQ process number among the HARQ process numbers is used.

In still another aspect, provided is a computer readable medium (CRM) storing instructions that cause an operation to be performed by at least one processor. The operation includes: receiving one downlink control information (DCI) related with scheduling of a plurality of data channels, and receiving or transmitting at least one data channel of the plurality of data channels based on the DCI. Each of the plurality of data channels is related with a different HARQ process number in ascending order. The DCI comprises information informing the at least one data channel based on a HARQ process number. The information comprises: i) a starting HARQ process number among HARQ process numbers related with the at least one data channel, and ii) a Discontinuous HARQ Process Indicator (DHPI) informing whether each HARQ process number following the starting HARQ process number among the HARQ process numbers is used.

In still another aspect, provided is a method of operating a base station in a wireless communication system. The method includes transmitting one downlink control information (DCI) related with scheduling of a plurality of data channels, and transmitting or receiving at least one data channel of the plurality of data channels based on the DCI. Each of the plurality of data channels is related with a different HARQ process number in ascending order. The DCI comprises information informing the at least one data channel based on a HARQ process number. The information comprises: i) a starting HARQ process number among HARQ process numbers related with the at least one data channel, and ii) a Discontinuous HARQ Process Indicator (DHPI) informing whether each HARQ process number following the starting HARQ process number among the HARQ process numbers is used.

In still another aspect, provided is a base station operated in a wireless communication system. The base station includes at least one transceiver, at least one memory and at least one processor operably coupled to the at least one memory. The at least one processor is adapted to: transmit one downlink control information (DCI) related with scheduling of a plurality of data channels, and transmit or receiving at least one data channel of the plurality of data channels based on the DCI. Each of the plurality of data channels is related with a different HARQ process number in ascending order. The DCI comprises information informing the at least one data channel based on a HARQ process number, wherein the information comprising: i) a starting HARQ process number among HARQ process numbers related with the at least one data channel, and ii) a Discontinuous HARQ Process Indicator (DHPI) informing whether each HARQ process number following the starting HARQ process number among the HARQ process numbers is used.

### Advantageous Effects

When transmitting multiple physical shared channels (PDSCH or PUSCH) using a single DCI, it is possible to transmit discontinuous HARQ processes without increasing the size of the DCI, thus increasing the data transfer rate and scheduling flexibility. Effects that can be obtained through specific examples of the present specification are not limited to the effects listed above. For example, various technical effects that a person having ordinary skill in the related art can understand or derive from this specification may exist. Accordingly, the specific effects of the present specification are not limited to those explicitly described herein, and may include various effects that can be understood or derived from the technical characteristics of the present specification.

### BRIEF DESCRIPTION OF THE DRAWINGS

FIG. 1 illustrates the system structure of a New Generation Radio Access Network (NG-RAN) with NR.

FIG. 2 illustrates the physical channels utilized in a 3GPP system and typical signal transmission.

FIG. 3 illustrates an example of a communication structure that may be provided in a 6G system.

FIG. 4 illustrates an electromagnetic spectrum.

FIG. 5 illustrates a frame structure.

FIG. 6 illustrates conventional HARQ operation.

FIG. 7 illustrates multiple TTI scheduling in which the NR-U schedules multiple PUSCHs through a single DCI.

FIG. 8 illustrates the case of discontinuous HARQ process retransmissions in multi-TTI scheduling.

FIG. 9 illustrates DCI with the addition of DHPI.

FIG. 10 illustrates an example of transmitting multiple PDSCHs with discontinuous HARQ process numbers using 2 bits of DHPI (NDHPI=2).

FIG. 11 illustrates a DCI format that includes a discontinuous HARQ process indicator (DHPI) without increasing the size of the DCI.

FIG. 12 illustrates a method of HARQ operation of a UE.

FIG. 13 illustrates a signaling process between a base station and a UE according to the method of FIG. 12.

FIG. 14 illustrates a more specific procedure for the UE to process the DCI for sending discontinuous HARQ processes to obtain a HARQ process number for each PXSCH.

FIG. 15 illustrates a communication system 1 applicable to the present disclosure.

FIG. 16 illustrates a wireless device that may be applied to the present disclosure.

FIG. 17 illustrates another example of a wireless device that can be applied to the present disclosure.

FIG. 18 illustrates a signal processing circuit for a transmission signal.

FIG. 19 illustrates a mobile device applicable to the present disclosure.

### MODE FOR INVENTION

The following techniques, devices and systems may be applied to a variety of wireless multiple access systems. Examples of multiple access systems include Code Division Multiple Access (CDMA) systems, Frequency Division Multiple Access (FDMA) systems. Time Division Multiple Access (TDMA) systems. Orthogonal Frequency Division Multiple Access (OFDMA) systems, and Single Access (SC-FDMA) systems. It includes a Carrier Frequency Division Multiple Access (MC-FDMA) system and a Multi-Carrier Frequency Division Multiple Access (MC-FDMA) system. CDMA can be implemented through wireless technologies such as Universal Terrestrial Radio Access (UTRA) or CDMA2000. TDMA can be implemented over wireless technologies such as Global System for Mobile communications (GSM), General Packet Radio Service (GPRS), or Enhanced Data rates for GSM Evolution (EDGE). OFDMA can be implemented through wireless technologies such as Institute of Electrical and Electronics Engineers (IEEE) 802.11 (Wi-Fi), IEEE 802.16 (WiMAX), IEEE 802.20, or Evolved UTRA (E-UTRA). UTRA is part of the Universal Mobile Telecommunications System (UMTS). 3rd Generation Partnership Project (3GPP) Long-Term Evolution (LTE) is part of Evolved UMTS (E-UMTS) using E-UTRA. 3GPP LTE uses OFDMA in the downlink (DL) and SC-FDMA in the uplink (UL). The evolution of 3GPP LTE includes LTE-A (Advanced), LTE-A Pro, and/or 5G NR (New Radio).

For convenience of explanation, implementations herein are primarily described in relation to a 3GPP based wireless communication system. However, the technical features of this specification are not limited to this. For example, the following detailed description is provided based on a mobile communication system corresponding to a 3GPP-based wireless communication system, but aspects of the present specification that are not limited to a 3GPP-based wireless communication system can be applied to other mobile communication systems.

For terms and technologies not specifically described among the terms and technologies used in this specification, reference may be made to wireless communication standard documents published prior to this specification.

In the present specification, “A or B” may mean “only A”, “only B” or “both A and B”. In other words, in the present specification, “A or B” may be interpreted as “A and/or B”. For example, in the present specification, “A, B, or C” may mean “only A”, “only B”, “only C”, or “any combination of A, B, C”.

A slash (/) or comma used in the present specification may mean “and/or”. For example, “A/B” may mean “A and/or B”. Accordingly, “A/B” may mean “only A”, “only B”, or “both A and B”. For example, “A, B, C” may mean “A, B, or C”.

In the present specification, “at least one of A and B” may mean “only A”, “only B”, or “both A and B”. In addition, in the present specification, the expression “at least one of A or B” or “at least one of A and/or B” may be interpreted as “at least one of A and B”.

In addition, in the present specification, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present specification may mean “for example”. Specifically, when indicated as “control information (PDCCH)”, it may mean that “PDCCH” is proposed as an example of the “control information”. In other words, the “control information” of the present specification is not limited to “PDCCH”, and “PDCCH” may be proposed as an example of the “control information”. In addition, when indicated as “control information (i.e., PDCCH)”, it may also mean that “PDCCH” is proposed as an example of the “control information”.

Technical features described individually in one drawing in this specification may be implemented individually or simultaneously.

Although not limited thereto, various descriptions, functions, procedures, suggestions, methods and/or operational flow diagrams disclosed herein may be applied to various fields requiring wireless communication and/or connectivity (e.g., 5G) between devices.

Hereinafter, this specification will be described in more detail with reference to the drawings. In the following drawings and/or descriptions, like reference numbers may refer to identical or corresponding hardware blocks, software blocks and/or functional blocks, unless otherwise indicated.

For clarity of explanation, the description is based on a 3GPP communication system (e.g., LTE, NR, etc.), but the technical idea of the present disclosure is not limited thereto. LTE refers to technology after 3GPP TS 36.xxx Release 8. In detail, LTE technology after 3GPP TS 36.xxx Release 10 is referred to as LTE-A, and LTE technology after 3GPP TS 36.xxx Release 13 is referred to as LTE-A pro. 3GPP NR refers to technology after TS 38.xxx Release 15. 3GPP 6G may refer to technologies after TS Release 17 and/or Release 18. “xxx” refers to the standard document detail number. LTE/NR/6G can be collectively referred to as a 3GPP system. Regarding background technology, terms, abbreviations, etc. used in the description of the present disclosure, reference may be made to matters described in standard documents published prior to the present disclosure.

Below, a transport block (TB) is described as an example of data, but this is not a limitation. That is, the data may be a code block, a code block group (CBG), etc. Content included in a transport block may also be referred to as a codeword.

NR supports multiple numerologies or subcarrier spacing (SCS) to support various 5G services. For example, if SCS is 15 kHz, it supports a wide area in traditional cellular bands, and if SCS is 30 kHz/60 kHz, it supports dense-urban, lower latency, and wider areas. It supports a wider carrier bandwidth, and when SCS is 60 kHz or higher, it supports a bandwidth greater than 24.25 GHz to overcome phase noise.

The NR frequency band can be defined as two types of frequency ranges (FR1, FR2). The values of the frequency range may vary. For example, the frequency ranges of the two types (FR1, FR2) may be as shown in Table 1 below. For convenience of explanation, among the frequency ranges used in the NR system, FRI may mean “sub 6 GHz range” and FR2 may mean “above 6 GHz range” and may be referred to as MilliMeter Wave (mmW).

TABLE 1

| Frequency range | Frequency | Subcarrier |
|---|---|---|
| designation | range | spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system can be changed. For example, FRI may include a band of 410 MHz to 7125 MHz as shown in Table 2 below. That is, FRI may include a frequency band of 6 GHz (or 5850, 5900, 5925 MHz, etc.). For example, the frequency band above 6 GHz (or 5850, 5900, 5925 MHz, etc.) included within FRI may include an unlicensed band. Unlicensed bands can be used for a variety of purposes, for example for communications for vehicles (e.g. autonomous driving).

TABLE 2

| Frequency range | Frequency | Subcarrier |
|---|---|---|
| designation | range | spacing |
| FR1 | 410 MHz-7125 MHz | 15, 30, 60 kHz |
| FR2 | 24250 MHz-52600 MHz | 60, 120, 240 kHz |

Here, wireless communication technologies implemented in the wireless device of this specification may include Narrow Band IoT (NB-IoT) for low-power communication as well as LTE, NR, and 6G. For example, NB-IoT technology may be an example of LPWAN (Low Power Wide Area Network) technology and may be implemented in standards such as LTE Cat NB1 and/or LTE Cat NB2, and is not limited to the above-mentioned names. Additionally or alternatively, the wireless communication technology implemented in the wireless device of the present specification may perform communication based on LTE-M technology. For example, LTE-M technology may be an example of LPWAN technology and may be called various names such as enhanced MTC (eMTC). For example, LTE-M technology may be implemented in at least one of a variety of specifications, including 1) LTE CAT 0, 2) LTE Cat M1, 3) LTE Cat M2, 4) LTE non-Bandwidth Limited (non-BL), 5) LTE-MTC, 6) LTE MTC, and/or 7) LTE M, and is not limited to the above designations. Additionally or alternatively, the wireless communication technologies implemented in the wireless devices of the present disclosure may include at least one of ZigBee, Bluetooth, and/or LPWAN with consideration for low power communication, and are not limited to the above designations. For example, Zigbee technology can create Personal Area Networks (PANs) for small/low-power digital communications based on various specifications such as IEEE 802.15.4, which can go by many names.

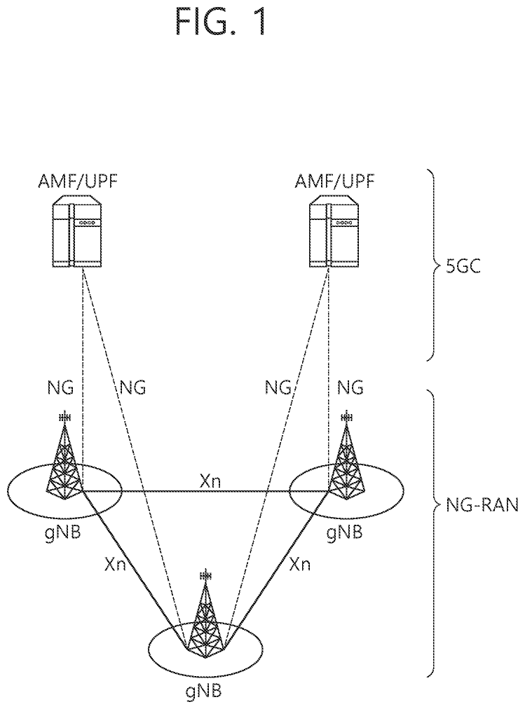

FIG. 1 illustrates the system structure of a next-generation radio access network (NG-RAN) to which NR is applied.

Referring to FIG. 1, NG-RAN may include a gNB and/or eNB that provide user plane and control plane protocol termination to the UE. FIG. 1 illustrates a case including only gNB. gNB and eNB are connected to each other through the Xn interface. The gNBs and eNBs are connected with the 5G Core Network (5GC) via NG interfaces. More specifically, the access and mobility management function (AMF) is connected via the NG-C interface, and the user plane function (UPF) is connected via the NG-U interface.

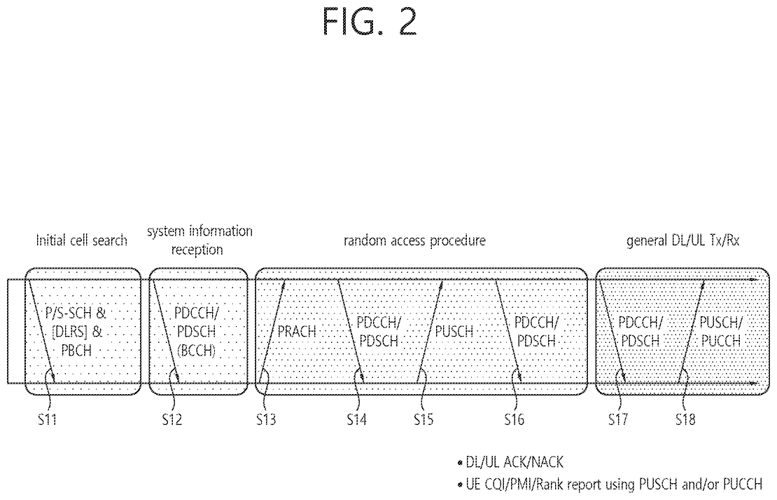

FIG. 2 illustrates physical channels and typical signal transmission used in a 3GPP system. In a wireless communication system, a UE receives information from a base station through downlink (DL), and the UE transmits information to the base station through uplink (UL). The information transmitted and received between the base station and the UE includes data and various control information, and various physical channels exist depending on the type/purpose of the information they transmit and receive.

The UE which is powered on or which newly enters a cell performs an initial cell search operation such as adjusting synchronization with the BS or the like (S11). To this end, the UE receives a primary synchronization channel (PSCH) and a secondary synchronization channel (SSCH) from the BS to adjust synchronization with the BS, and acquire information such as a cell identity (ID) or the like. In addition, the UE may receive a physical broadcast channel (PBCH) from the BS to acquire broadcasting information in the cell. In addition, the UE may receive a downlink reference signal (DL RS) in an initial cell search step to identify a downlink channel state.

Upon completing the initial cell search, the UE may receive a physical downlink control channel (PDCCH) and a physical downlink control channel (PDSCH) corresponding thereto to acquire more specific system information (S12).

Meanwhile, if there are no radio resources to connect to the base station for the first time or to transmit a signal, the UE may perform a random access procedure (RACH, which may also be referred to as a random access process) to the base station (S13 to S16). To do this, the UE may transmit a specific sequence as a preamble over the Physical Random Access Channel (PRACH) (S13 and S15) and receive a response message (Random Access Response (RAR) message) to the preamble over the PDCCH and the corresponding PDSCH. In the case of contention-based RACH, an additional conflict resolution procedure can be performed (S16).

After performing the procedure described above, the UE can then perform PDCCH/PDSCH reception (S17) and Physical Uplink Shared Channel (PUSCH)/Physical Uplink Control Channel (PUCCH) transmission (S18) as a normal uplink signal transmission procedure. In particular, the UE may receive downlink control information (DCI) via PDCCH. The DCI includes control information, such as resource allocation information for the UE, and may be formatted differently depending on the intended use.

On the other hand, the control information transmitted by the UE to the base station via the uplink or received by the UE from the base station may include downlink/uplink ACK/NACK signals, channel quality indicators (CQI), precoding matrix indices (PMI), rank indicators (RI), etc. The UE may transmit control information such as CQI/PMI/RI described above via PUSCH and/or PUCCH.

### <Structure of Uplink and Downlink Channels>

### 1. Downlink Channel Structure

The base station transmits related signals to the UE through a downlink channel described later, and the UE receives related signals from the base station through a downlink channel described later.

### (1) Physical Downlink Shared Channel (PDSCH)

PDSCH carries downlink data (e.g., DL-shared channel transport block, DL-SCH TB) and is subject to modulation methods such as Quadrature Phase Shift Keying (QPSK), 16 Quadrature Amplitude Modulation (QAM), 64 QAM, 256 QAM, etc. A codeword is generated by encoding TB. PDSCH can carry multiple codewords. Each codeword is scrambled and modulation mapped, and the modulation symbols generated from each codeword are mapped to one or more layers (Layer mapping). Each layer is mapped to resources along with DMRS (Demodulation Reference Signal), generated as an OFDM symbol signal, and transmitted through the corresponding antenna port.

### (2) Physical Downlink Control Channel (PDCCH)

PDCCH carries downlink control information (DCI) and QPSK modulation method is applied. One PDCCH consists of 1, 2, 4, 8, or 16 CCEs (Control Channel Elements) depending on the AL (Aggregation Level). One CCE consists of six REGs (Resource Element Group). One REG is defined by one OFDM symbol and one (P) RB.

The UE obtains DCI transmitted through the PDCCH by performing decoding (aka blind decoding) on a set of PDCCH candidates. The set of PDCCH candidates that the UE decodes is defined as the PDCCH search space set. The search space set may be a common search space or a UE-specific search space. The UE can obtain DCI by monitoring PDCCH candidates within one or more search space sets set by MIB or higher layer signaling.

### 2. Uplink Channel Structure

The UE transmits the relevant signals to the base station via the uplink channel described above, and the base station receives the relevant signals from the UE via the uplink channel described above.

### (1) Physical Uplink Shared Channel (PUSCH)

PUSCH carries uplink data (e.g., UL-shared channel transport block, UL-SCH TB) and/or uplink control information (UCI) and is transmitted based on a CP-OFDM (Cyclic Prefix-Orthogonal Frequency Division Multiplexing) waveform, DFT-s-OFDM (Discrete Fourier Transform-spread-Orthogonal Frequency Division Multiplexing) waveform, etc. When the PUSCH is transmitted based on the DFT-s-OFDM waveform, the UE transmits the PUSCH by applying transform precoding. For example, when transform precoding is not possible (e.g., transform precoding is disabled), the UE may transmit PUSCH based on the CP-OFDM waveform, and when transform precoding is possible (e.g., transform precoding is enabled), the UE may transmit PUSCH based on the CP-OFDM waveform or the DFT-s-OFDM waveform. PUSCH transmissions can be dynamically scheduled by UL grants within the DCI, or semi-statically scheduled based on higher layer (e.g., RRC) signaling (and/or Layer 1 (L1) signaling (e.g., PDCCH)) (configured grant). PUSCH transmission can be performed based on codebook or non-codebook.

### (2) Physical Uplink Control Channel (PUCCH)

A PUCCH carries uplink control information, HARQ-ACKs and/or scheduling requests (SRs) and may be divided into multiple PUCCHs based on the length of the PUCCH transmission.

### <6G System General>

The 6G (wireless communication) system is aimed at (i) very high data rates per device, (ii) a very large number of connected devices, (iii) global connectivity, (iv) very low latency, (v) lower energy consumption for battery-free IoT devices, (vi) ultra-reliable connectivity, and (vii) connected intelligence with machine learning capabilities. The vision of the 6G system can be four aspects, such as intelligent connectivity, deep connectivity, holographic connectivity, and ubiquitous connectivity, and the 6G system can satisfy the requirements as shown in Table 3 below. In other words, Table 3 is an example of the requirements of the 6G system.

TABLE 3

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | Up to 1000 km/hr |
| Satellite integration | Fully |
| Artificial intelligence (AI) | Fully |
| Autonomous vehicle | Fully |
| Extended Reality (XR) | Fully |
| Haptic Communication | Fully |

6G systems may have key factors such as enhanced mobile broadband (eMBB), ultra-reliable low latency communications (URLLC), massive machine-type communication: (mMTC), AI integrated communication, tactile internet, high throughput, high network capacity, high energy efficiency, low backhaul and access network congestion, and enhanced data security.

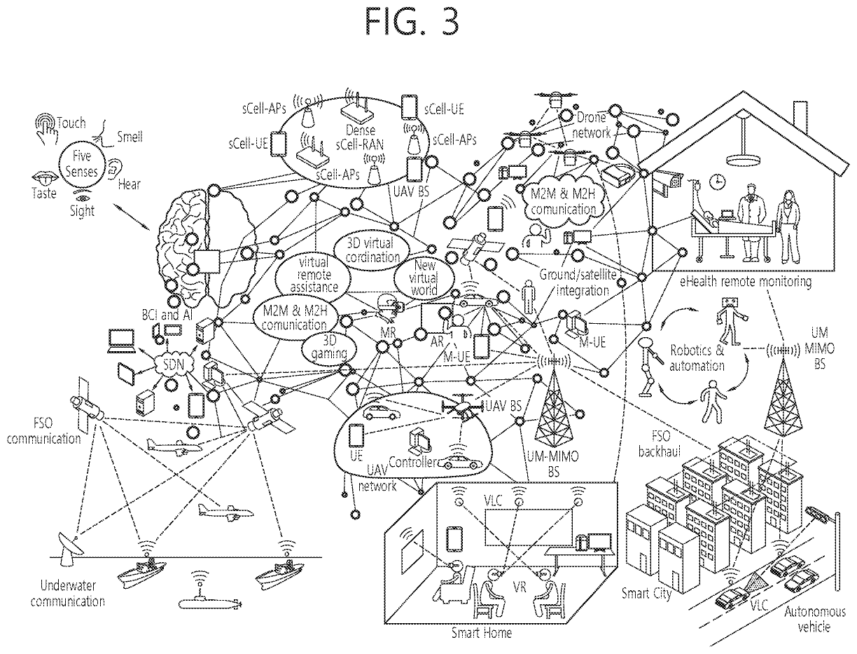

FIG. 3 is a diagram showing an example of a communication structure that can be provided in a 6G system.

The 6G system is expected to have simultaneous wireless communication connectivity that is 50 times higher than that of the 5G wireless communication system. URLLC, a key feature of 5G, will become an even more mainstream technology in 6G communications by providing end-to-end delays of less than 1 ms. The 6G system will have much better volumetric spectral efficiency, unlike the frequently used area spectral efficiency. 6G systems can offer very long battery life and advanced battery technologies for energy harvesting, so mobile devices will not need to be charged separately in a 6G system. New network characteristics in 6G may include:

Satellites integrated network: To provide a global mobile population, 6G is expected to be integrated with satellites. The integration of terrestrial, satellite, and airborne networks into a single wireless communication system is critical to 6G.

Connected intelligence: Unlike previous generations of wireless communication systems, 6G is revolutionary and will update the wireless evolution from “connected things” to “connected intelligence”. AI can be applied at each step of the communication process (or each step of signal processing, as we will see later).

Seamless integration wireless information and energy transfer: 6G wireless networks will deliver power to charge the batteries of devices such as smartphones and sensors. Therefore, wireless information and energy transfer (WIET) will be integrated.

Ubiquitous super 3D connectivity: Access to networks and core network functions from drones and very low Earth orbit satellites will create super 3D connectivity at 6G ubiquity.

In the above new network characteristics of 6G, some general requirements may be as follows.

Small cell networks: The idea of small cell networks was introduced to improve the quality of received signals in cellular systems as a result of improved throughput, energy efficiency, and spectral efficiency. As a result, small cell networks are an essential characteristic for 5G and beyond 5G (5 GB) communication systems. Therefore, 6G communication systems will also adopt the characteristics of small cell networks.

Ultra-dense heterogeneous networks: Ultra-dense heterogeneous networks will be another important characteristic of 6G communication systems. Multi-tier networks composed of heterogeneous networks will improve overall QoS and reduce costs.

High-capacity backhaul: Backhaul connectivity is characterized by high-capacity backhaul networks to support large volumes of traffic. High-speed fiber optics and free-space optics (FSO) systems are possible solutions to this problem.

Radar technology integrated with mobile technology: High-precision localization (or location-based services) over communications is one of the features of 6G wireless communication systems. Therefore, radar systems will be integrated with 6G networks.

Softwarization and virtualization: Softwarization and virtualization are two important features that are fundamental to the design process in a 5 GB network to ensure flexibility, reconfigurability, and programmability. In addition, billions of devices may be shared on a shared physical infrastructure.

### <THz (Terahertz) Communications>

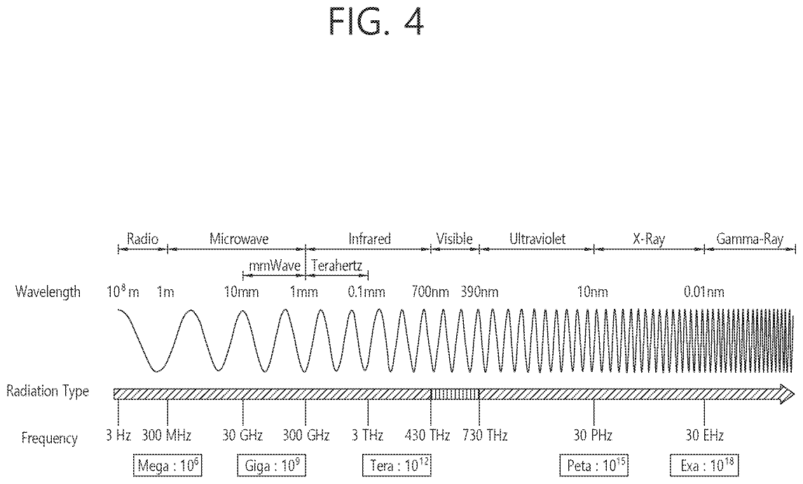

FIG. 4 illustrates the electromagnetic spectrum.

The data transfer rate can be increased by increasing the bandwidth. This can be accomplished by using sub-THz communications with wide bandwidth and applying advanced massive MIMO technology. THz waves, also known as submillimeter radiation, typically represent a frequency band between 0.1 THz and 10 THz with a corresponding wavelength in the range 0.03 mm˜3 mm. The 100 GHz-300 GHz band range (Sub THz band) is considered the main part of the THz band for cellular communications. Adding the Sub-THz band to the mmWave band increases 6G cellular communication capacity. Among the defined THz bands, 300 GHz˜3THz is in the far infrared (IR) frequency band.

The key characteristics of THz communications include (i) widely available bandwidth to support very high data rates, and (ii) high path loss at high frequencies (highly directional antennas are indispensable). The narrow beamwidth produced by highly directive antennas reduces interference. The small wavelength of THz signals allows a much larger number of antenna elements to be integrated into devices and BSs operating in this band. This enables the use of advanced adaptive array techniques that can overcome range limitations.

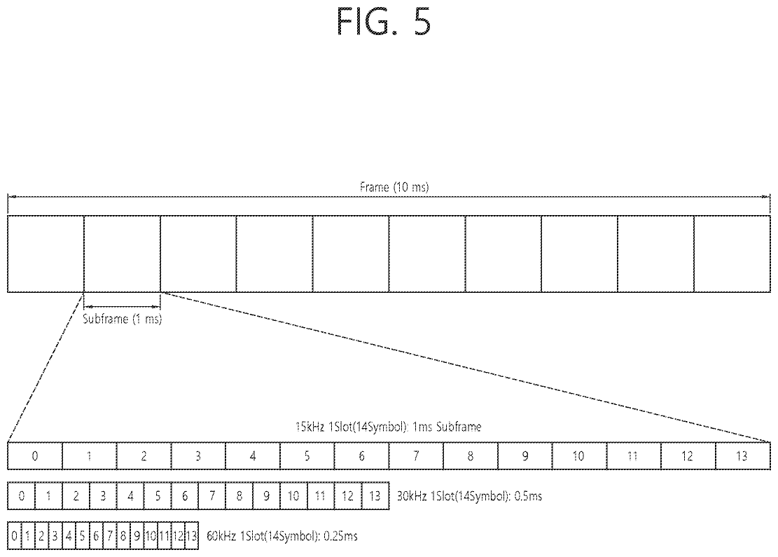

FIG. 5 illustrates a frame structure.

Referring to FIG. 5, a frame may consist of 10 milliseconds (ms) and may include 10 subframes of 1 ms each.

A subframe can contain one or multiple slots, depending on the subcarrier spacing (SCS).

The following Table 4 shows an example of a subcarrier spacing configuration μ.

TABLE 4

| μ | Δf = 2^{μ} · 15[kHz] | CP(Cyclic Prefix) |
|---|---|---|
| 0 | 15 | Normal |
| 1 | 30 | Normal |
| 2 | 60 | Normal, Extended |
| 3 | 120 | Normal |
| 4 | 240 | Normal |

The following Table 5 shows the number of slots in a frame (N^{frame,μ}ₛₗₒₜ), the number of slots in a subframe (N^{subframe,μ}ₛₗₒₜ), and the number of symbols in a slot (N^{slot}_{symb}), depending on the subcarrier spacing configuration μ.

TABLE 5

| μ | N_{symb}^{slot} | Nₛₗₒₜ^{frameμ,} | Nₛₗₒₜ^{subframeμ,} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

In FIG. 5, an example is shown for μ=0, 1, and 2.

In THz communications, SCS can be set to be louder than 240 KHz (e.g., 480 KHz).

Now, hybrid automatic repeat request (HARQ) operation is described. The HARQ method combines forward error correction (FEC) and automatic repeat request (ARQ), and it improves performance by checking whether the data received by the physical layer contains undecipherable errors and, if errors occur, requiring retransmission.

In HARQ, the receiver notifies the transmitter of successful reception by sending an ACK (acknowledgment) signal as a reception acknowledgment if no errors are detected in the received data. When a receiver detects an error in the data it receives, it sends a negative acknowledgment (NACK) signal as an acknowledgment of receipt to notify the transmitter of the error detection. The transmitter can retransmit the data when it receives the NACK signal.

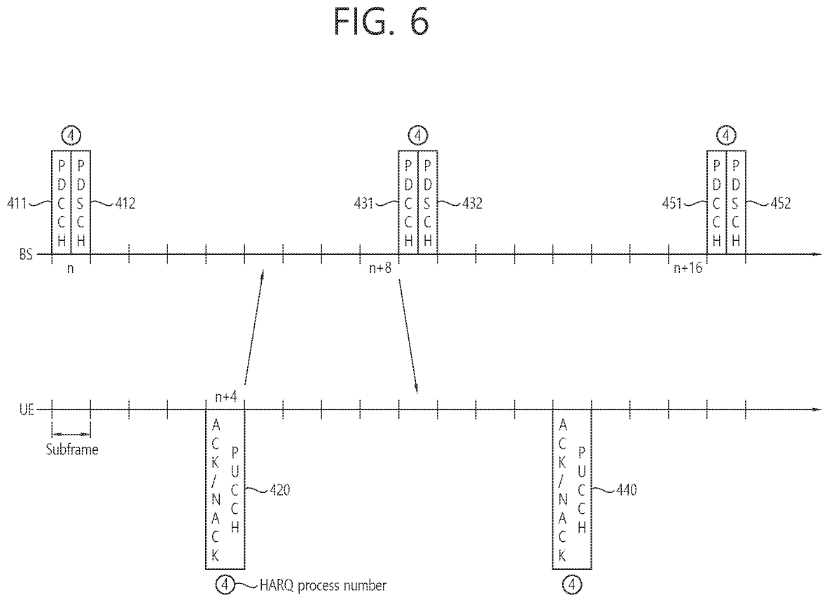

FIG. 6 illustrates a conventional HARQ operation.

Referring to FIG. 6, the first device (e.g., a base station) transmits a downlink transport block to the second device (e.g., a UE) on the PDSCH 412 indicated by the downlink resource allocation on the PDCCH 411 in subframe n.

The UE sends an acknowledgment/negative acknowledgment (ACK/NACK) signal on the PUCCH 420 in subframe n+4. In one example, the resource of the PUCCH 420 used to transmit the ACK/NACK signal may be determined based on the resource of the PDCCH 411 (e.g., the index of the first CCE used to transmit the PDCCH 411).

When the base station receives a NACK signal from the UE, unlike the uplink HARQ, it does not necessarily retransmit in subframe n+8. Here, an example is shown of retransmitting a transport block on PDSCH 432 in subframe n+9, which is dictated by the downlink resource allocation on PDCCH 431.

The UE sends an ACK/NACK signal on the PUCCH (440) in the n+13th subframe. It is common to transmit ACK/NACK signals after decoding is completed in the UE's decoder.

The present disclosure will now be described.

The present disclosure relates to methods and apparatus for enabling the transmission of discontinuous HARQ processes while minimizing the size of control information when scheduling two or more physical data channels supporting Hybrid Automatic Repeat and reQuest (HARQ) in a wireless communication system via a single piece of the control information.

The rapid growth of data traffic in cellular mobile communication systems has led to the development of technologies to transmit data over unlicensed spectrum bands. Because unlicensed bands can share frequencies with other communications systems, such as Wi-Fi, it may be necessary to design channel access schemes that allow multiple wireless access technologies to coexist. For example, unlicensed bands may be designed to use a channel access scheme based on energy detection operation.

LTE-LAA (Licensed Assisted Access) and NR-U (New Radio Unlicensed) support Listen Before Talk (LBT) technology, which enables frequency sharing between multiple radio access technologies under the Carrier Sensing Multiple Access/Collision Avoidance (CSMA/CA) procedure.

Transmitting data in unlicensed bands may always involve LBT operation. Therefore, the typical transmission method of scheduling one uplink data channel (e.g., physical uplink shared channel (PUSCH)) via one downlink control information (DCI) may result in a significant degradation of the uplink data rate. Therefore, LTE-eLAA (enhanced LAA) and NR-U introduce multi-TTI scheduling technology that allows multiple PUSCHs to be scheduled through a single DCI.

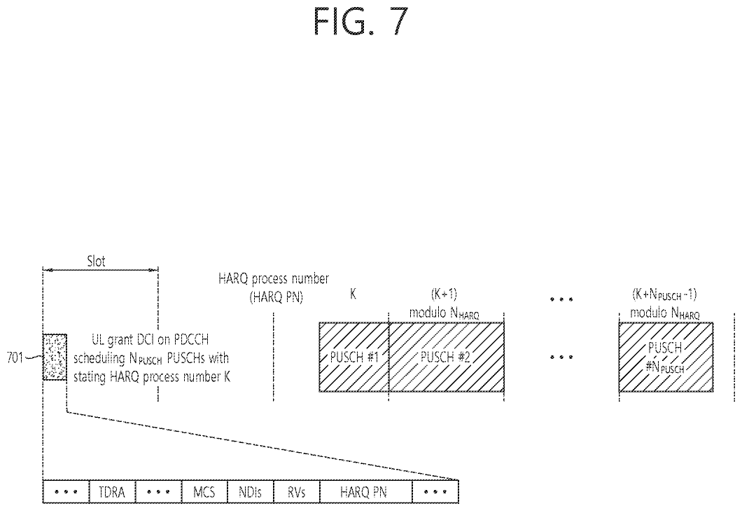

FIG. 7 illustrates multiple TTI scheduling in NR-U, scheduling multiple PUSCHs through one DCI.

Referring to FIG. 7, the UE may receive a DCI comprising an uplink grant in the first slot 701 via the physical downlink control channel (PDCCH). The DCI may include information for scheduling N_{PUSCH} (e.g., eight) PUSCHs. The N_{PUSCH} PUSCHs may start from HARQ process number K. That is, PUSCH #1 can be given a HARQ process number of K, PUSCH #2 can be given a HARQ process number of (K+1) modulo N_{HARQ}, . . . , PUSCH #N_{PUSCH} can be given a HARQ process number of (K+N_{PUSCH}−1) modulo N_{HARQ}, and so on. Where N_{HARQ} is the number of HARQ processes in operation.

The information carried over the DCI can include, for example, a Time Domain Resource Assignment (TDRA), a Modulation and Coding Scheme (MCS), multiple New Data Indicators (NDIs), multiple Redundancy Versions (RVs), and a HARQ Process Number (PN).

For example, the DCI may be DCI format 0_1. DCI format 0_1 is a DCI format used to schedule one or more PUSCHs in a cell, or to instruct a UE to CG Downlink Feedback Information (CG-DFI).

The TDRA can provide the number of PUSCHs being scheduled, as well as the index of a TDRA table that contains time domain resource allocation information such as the start symbol and length for each PUSCH. An example of a TDRA table is shown below.

TABLE 6

| | PUSCH | | | |
|---|---|---|---|---|
| Row | mapping | | | |
| index | type | K₂ | S | L |
| 1 | Type A | j | 0 | 14 |
| 2 | Type A | j | 0 | 12 |
| 3 | Type A | j | 0 | 10 |
| 4 | Type B | j | 2 | 10 |
| 5 | Type B | j | 4 | 10 |
| 6 | Type B | j | 4 | 8 |
| 7 | Type B | j | 4 | 6 |
| 8 | Type A | j + 1 | 0 | 14 |
| 9 | Type A | j + 1 | 0 | 12 |
| 10 | Type A | j + 1 | 0 | 10 |
| 11 | Type A | j + 2 | 0 | 14 |
| 12 | Type A | j + 2 | 0 | 12 |
| 13 | Type A | j + 2 | 0 | 10 |
| 14 | Type B | j | 8 | 6 |
| 15 | Type A | j + 3 | 0 | 14 |
| 16 | Type A | j + 3 | 0 | 10 |

In the above table, the slot offset K₂ (the slot offset between the slot receiving the uplink scheduling DCI and the slot performing the uplink transmission), the start symbol S for the start of the slot, and the number of consecutive symbols L counted from the symbol S assigned to PUSCH may be indicated by the TDRA indicating the row index of the above table.

From the information provided by the TDRA, the UE can know or obtain the number of PUSCHs scheduled through each DCI. The MCS can be applied equally to all PUSCHs. The NDI and RV can consist of as many bits as the maximum number of PUSCHs that can be scheduled by the TDRA table, one bit for each PUSCH. The HARQ PN may indicate the HARQ process number (=HARQ PN) of the first PUSCH (PUSCH #1). The HARQ process numbers of the second and subsequent PUSCHs may have sequential values from the HARQ process number of the first PUSCH.

That is, FIG. 7 is an example of a case where NPUSCH PUSCHs where the HARQ PN of the first PUSCH is K are scheduled by the DCI. In this way, scheduling multiple data channels through one DCI may be referred to as multiple Transmission Time Interval (TTI) scheduling.

Multi-TTI scheduling is one of the technologies to reduce power consumption of the UE in bands above 52 GHz and is expected to be applied to PDSCH scheduling as well as PUSCH.

However, as the frequency of the carrier increases, phase noise becomes a major factor that degrades the performance of the communication system. The OFDM system adopted by NR can mitigate the performance degradation caused by phase noise by widening the space between subcarriers (Sub-Carrier Spacing (SCS)). For this reason. NR uses a wider SCS as the frequency of the carriers increases. As shown in FIG. 5, for the same number of subcarriers, the length of the OFDM symbols and the slot consisting of 14 OFDM symbols becomes shorter as the SCS becomes larger. If the UE attempts to receive PDCCHs in every slot, the UE's power consumption will increase as the slot length decreases.

For example, there is a need to solve this problem in a band of 52.6 GHz or higher. As a solution to this, there is a method in which the UE attempts to receive PDCCH in a cycle that includes a plurality of slots rather than every slot. By increasing the PDCCH reception period, an increase in power consumption of the UE can be prevented, but the problem of a decrease in data transmission speed occurs. Standardization of technology for scheduling multiple PUSCHs or PDSCHs through one DCI is in progress.

Hereinafter, the symbols/abbreviations/terms used in this specification are as follows.

AMC: Adaptive Modulation and Coding, AR: Augmented Reality, ARQ: Automatic Repeat request, BER: Bit Error Rate, BLER: Block Error Rate, CB: Code Block, CBG: Code Block Group, CC: Chase Combining, CE: Control Element, CQI: Channel Quality Indicator, CR: Coding Rate, CRC: Cyclic Redundancy Check, CSI: Channel State Information, DCI: Downlink Control Information, DHPI: Discontinuous HARQ Process Indicator, DL: DownLink, DL-SCH: Downlink Shared Channel, HARQ: Hybrid Automatic Repeat request, ID: Identifier, IR: Incremental Redundancy, L1: Layer 1, LCG: Logical Channel Group, LTE: Long-Term Evolution, MAC: Medium Access Control, MCS: Modulation and Coding Scheme, MIMO: Multiple Input Multiple Output, NDI: New Data Indicator, NR: New Radio, PDCCH: Physical Downlink Control Channel, PDSCH: Physical Downlink Shared Channel, PDU: Packet Data Unit, PTB: Primary Transport Block, PUCCH: Physical Uplink Control Channel, PUSCH: Physical Uplink Shared Channel, QoS: Quality of Service, RA: Resource Assignment, RLC: Radio Link Control, RV: Redundancy Version, SDU: Service Data Unit, SINR: Signal to Interference and Noise Ratio, SNS: Social Networking Service, STB: Secondary Transport Block, TB: Transport Block, TDRA: Time Domain Resource Assignment, TTI: Transmit Time Interval, UL: UpLink, UL-SCH: Uplink Shared Channel, VR: Virtual Reality.

The present disclosure describes apparatus and methods for enabling the transmission of discontinuous HARQ processes while minimizing the size of control information when scheduling two or more physical channels supporting HARQ in a wireless communication system via a single piece of the control information.

Conventional multiple TTI scheduling techniques are designed so that the HARQ process numbers of multiple physical shared channels (such as PDSCH or PUSCH, hereafter referred to as PXSCH) scheduled through a single DCI have consecutive values. This was done to prevent the number of bits in the DCI from increasing to carry the HARQ process number. However, in actual wireless communication situations, it may be difficult to maintain the continuity of the HARQ process number.

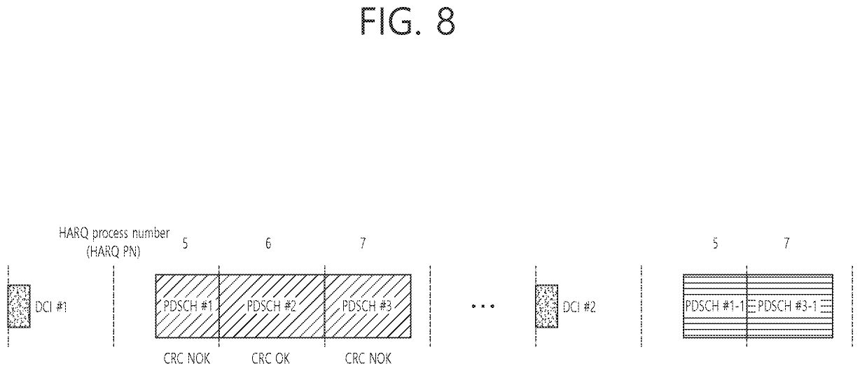

FIG. 8 illustrates a case where discontinuous HARQ process retransmission occurs in multi-TTI scheduling.

Referring to FIG. 8, the base station can schedule PDSCH #1 to #3 with consecutive HARQ process numbers through DCI #1. For example, the UE may successfully decode PDSCH #2, but fail to decode PDSCH #1 and PDSCH #3. Then, the UE can inform the base station of this. For example, the UE can feed back ACK for PDSCH #2 and NACKs for PDSCH #1 and PDSCH #3.

In this case, when the base station attempts to schedule PDSCH #1-1 and PDSCH #3-1, which are retransmissions of PDSCH #1 and PDSCH #3, through DCI #2, there may be no new data to transmit through HARQ process number 6. Then, a problem occurs with the conventional technology because the HARQ process numbers of PDSCH #1-1 (HARQ process number=5) and PDSCH #3-1 (HARQ process number=7) are discontinuous.

It can be considered splitting DCI #2 into two DCIs and scheduling PDSCH #1-1 and PDSCH #3-1 respectively, but this requires additional PDCCH resources and increases the maximum number of DCIs that the UE should receive and process at one time, which increases the power consumption of the UE.

The present disclosure adds information to the DCI indicating whether the HARQ process following the HARQ process of the first PXSCH is discontinuous or not to allow the transmission of discontinuous HARQ processes while minimizing the increase in the number of bits in the DCI.

The information that informs whether a HARQ process is discontinuous is hereafter referred to as the Discontinuous HARQ Process Indicator (DHPI) for convenience.

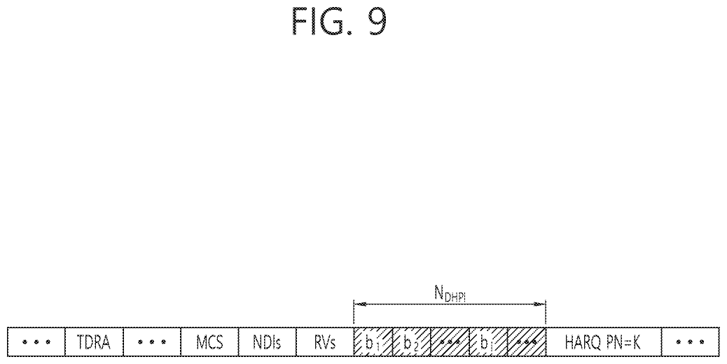

FIG. 9 shows an example of a DCI with DHPI added.

Referring to FIG. 9, the DCI may include, for example, a TDRA, an MCS, a plurality of NDIs, a plurality of RVs, a plurality of DHPIs, and a HARQ PN field.

If the value of the HARQ PN field is given as, for example, K, where K represents the HARQ process number of the first PXSCH.

N_{DHPI} represents the number of bits in the DHPI field. In the DHPI field, bᵢ is the value of the i (=1, . . . , N_{DHPI})th DHPI bit. bᵢ indicates whether the HARQ process number (K+i) is used for PXSCH transmission. For example, a bᵢ of 0 means that the HARQ process number (K+i) is used and a bᵢ of 1 means that it is not used (and vice versa). If i is greater than N_{DHPI}, bᵢ can be defined as 0 to assume that the HARQ process number (K+i) is used to alleviate the limitation of the number of schedulable PXSCHs by the number of discontinuous HARQ process indicator bits.

The HARQ process number of the scheduled PXSCH is sequentially allocated to HARQ process numbers with bᵢ of 0, including K, the starting HARQ process number.

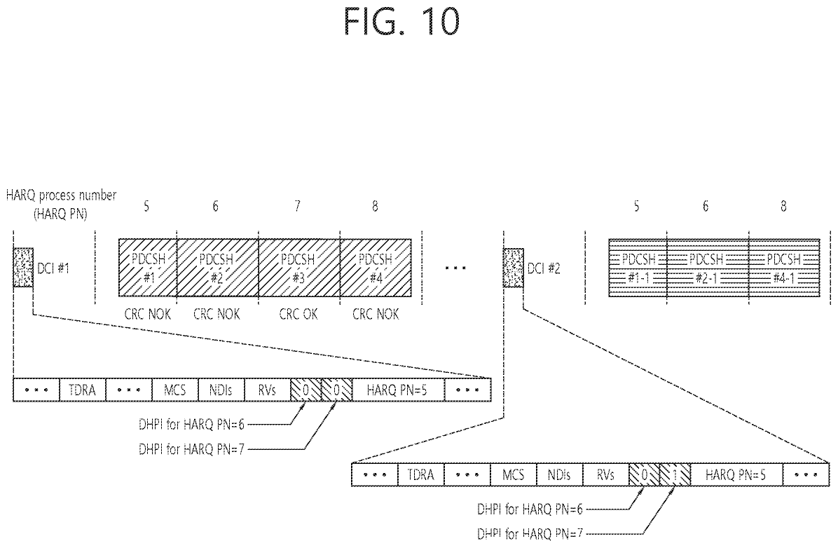

FIG. 10 shows an example of transmitting a plurality of PDSCHs with discontinuous HARQ process numbers using DHPI of 2 bits (N_{DHPI}=2).

Referring to FIG. 10, DCI #1 and DCI #2 each contain two bits of DHPI. Since the starting HARQ process number carried by each DCI is 5, the two DHPI bits indicate whether HARQ processes 6 and 7 are enabled or disabled, respectively.

For example, in DHPI of DCI #1, b₁ may be 0 and b₂ may also be 0, which means that both HARQ processes 6 and 7 are used. HARQ process 8 is assumed to be used because there is no explicit DHPI. Accordingly, consecutive HARQ process numbers from 5 to 8 are assigned to PDSCH #1 to PDSCH #4.

Suppose the device decodes PDSCH #1 through PDSCH #4, and the device does not decode correctly for PDSCH #1 (HARQ process number 5), PDSCH #2 (HARQ process number 6), and PDSCH #4 (HARQ process number 8) (CRC check result is Not-OK), and only decodes correctly for PDSCH #3 (HARQ process number 7) (CRC check result is OK).

Then, the base station will need to schedule PDSCH #1-1 (HARQ process number 5). PDSCH #2-1 (HARQ process number 6), and PDSCH #4-1 (HARQ process number 8) which are retransmission for PDSCH #1 (HARQ process number 5). PDSCH #2 (HARQ process number 6), and PDSCH #4 (HARQ process number 8), respectively, through DCI #2. In this case, the DHPI of DCI #2 gives b₁ as 0 and b₂ as 1, indicating that HARQ process 6 is used and 7 is not used. In this case too. HARQ process 8 can be assumed to be used since there is no explicit DHPI.

Transmission of discontinuous HARQ processes is possible through the addition of the discontinuous HARQ process indicator (DHPI), but there is a problem in that the size of DCI increases. A method to solve this problem is explained.

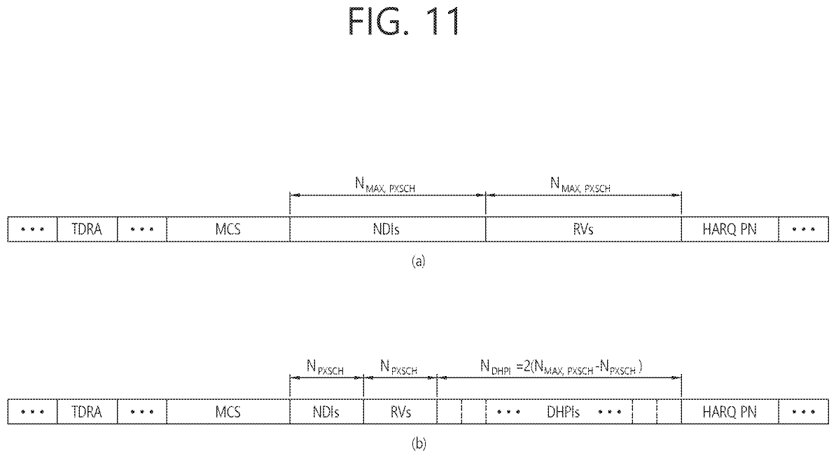

FIG. 11 illustrates a DCI format including a discontinuous HARQ process indicator (DHPI) without increasing the size of the DCI.
(a) of FIG. 11 is a DCI format that schedules multiple PUSCHs through one DCI in NR-U. In this DCI format, the MCS field and HARQ process number field are fixed to 5 bits and 4 bits, respectively. The NDI and RV, one bit for each PUSCH, are allocated to the maximum number of PUSCHs that can be scheduled by the TDRA table (N_{MAX,PXSCH}), but are only used for as many PUSCHs as are actually scheduled (N_{PXSCH}). Therefore, 2(N_{MAX,PXSCH}−N_{PXSCH}) worth of NDI and RV bits will be unused.

In this case, these 2(N_{MAX,PXSCH}−N_{PXSCH}) bits can be used as DHPI, as shown in (b) of FIG. 11. This allows for the transmission of discontinuous HARQ processes without increasing the number of bits in the DCI format.

The DCI format for sending discontinuous HARQ processes in multi-TTI scheduling, as shown in (b) of FIG. 11, may include the following information.
i) HARQ process number of the first PXSCH (HARQ PN field)
ii) NDIs (NDIs field) as many as the number of scheduled PXSCHs (N_{PXSCH})
iii) RVs (RVs field) as many as the number of scheduled PXSCHs (N_{PXSCH})
iv) Discontinuous HARQ process indicators as many as N_{DHPI}=2(N_{MAX,PXSCH}−N_{PXSCH}), (N_{MAX,PXSCH} is the maximum number of PXSCHs that can be scheduled by the TDRA table)

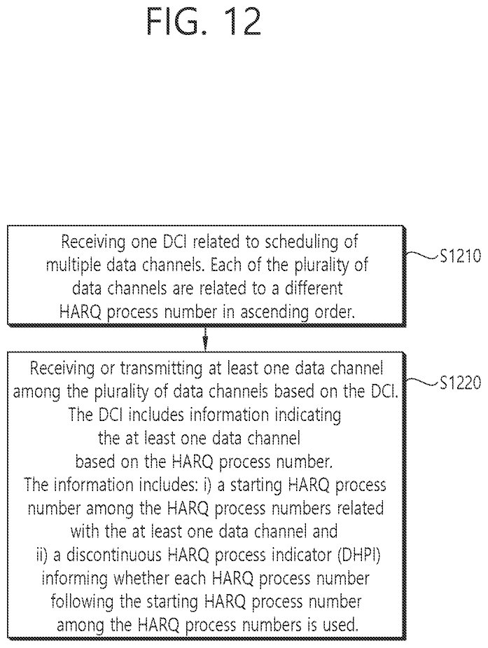

FIG. 12 illustrates a HARQ operation method of a UE.

Referring to FIG. 12, the UE receives one DCI related to scheduling of multiple data channels (S1210). Each of the plurality of data channels may be related to a different HARQ process number in ascending order.

The UE receives or transmits at least one data channel among the plurality of data channels based on the DCI (S1220).

The DCI includes information indicating the at least one data channel based on the HARQ process number. Specifically, the information includes: i) a starting HARQ process number (determined based on the HARQ process number field) among the HARQ process numbers related with the at least one data channel; and ii) a discontinuous HARQ process indicator (determined based on the DHPI field) informing whether each HARQ process number following the starting HARQ process number among the HARQ process numbers is used.

The UE shall receive or transmit a data channel related with the starting HARQ process number and a data channel related with the HARQ process number informed to be used by the DHPI field.

As described above, the DCI may further comprise a time domain resource assignment (TDRA) field, new data indicator (NDI) fields (i.e., comprising a plurality of NDIs), and redundancy version (RV) fields (i.e., comprising a plurality of RVs).

The maximum number of the above NDI fields may be N_{MAX,PXSCH} and the maximum number of the above RV fields may be N_{MAX,PXSCH}. Here, N_{MAX,PXSCH} may mean the maximum number of data channels that can be scheduled based on the value of the TDRA field. When the DHPI field is not included in the DCI, the bit size of the NDI fields may be N_{MAX,PXSCH}, and the bit size of the RV fields may also be N_{MAX,PXSCH}.

Only a smaller number of data channels (N_{PXSCH}) than the maximum number of data channels (N_{MAX,PXSCH}) that can be scheduled through the DCI can actually be scheduled. In this case, the bit size of the NDI fields included in the DCI is N_{PXSCH}, and the bit size of the RV fields included in the DCI is N_{PXSCH}. And, the bit size of the field containing the DHPI (DHPI field) may be 2 (N_{MAX,PXSCH}−N_{PXSCH}).

However, bit size of the DHPI field, 2(N_{MAX,PXSCH}−N_{PXSCH}), is the DHPI field size assuming that the RV for each PXSCH is 1 bit. RV for each PXSCH may have a value of 2 bits or more. In this case, Equation 2(N_{MAX,PXSCH}−N_{PXSCH}) may be changed. In general, if the number of RV bits for each PXSCH is N_{RV}, the DHPI field size can be expressed as (1+N_{RV})(N_{MAX,PXSCH}−N_{PXSCH}).

If there is no change in the size of the remaining fields of the DCI, the bit size of the DCI does not change both when the DHPI field is included in the DCI and when it is not (prior art). In other words, it is possible to transmit discontinuous HARQ processes without increasing the bit size of DCI compared to the prior art.

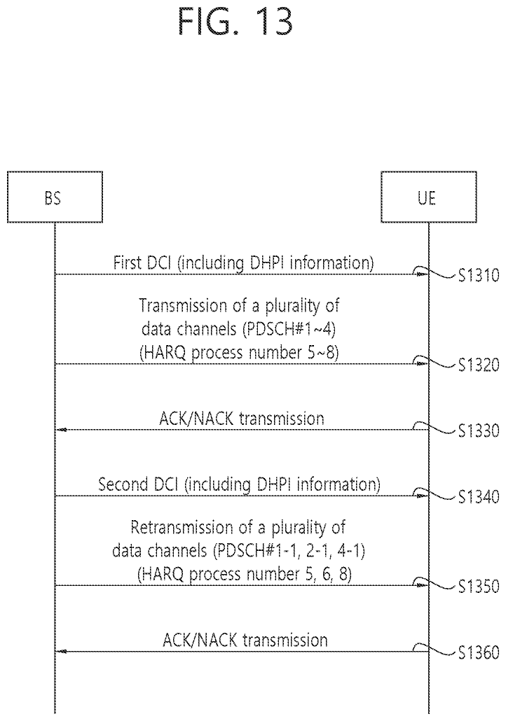

FIG. 13 illustrates the signaling process between the base station and the UE according to the method of FIG. 12.

Referring to FIG. 13, the base station transmits the first DCI to the UE (S1310). The first DCI includes DHPI information.

For example, the UE can receive scheduling of a plurality of downlink data channels (PDSCH #1 to PDSCH #4) through the first DCI. In this case, each of the plurality of PDSCHs can be related with a different HARQ process number in ascending order, such as PDSCH #1 is related with HARQ process number 5, PDSCH #2 is related with HARQ process number 6, PDSCH #3 is related with HARQ process number 7, PDSCH #4 is related with HARQ process number 8, and so on.

Let's assume that the value of the HARQ process number field included in the first DCI is 5, the DHPI field is 2 bits, and the value of each bit is given as ‘0’ and ‘0’. This means that the starting HARQ process #5 indicated by the HARQ process number field and the following HARQ processes #6 and #7 are used. HARQ process #8 can be assumed to be used since there is no explicit DHPI.

The base station transmits data channels (PDSCH #1 to #4, HARQ process numbers 5 to 8 in order) scheduled by the DCI (S1320).

The UE decodes the above data channels and feedback ACK/NACK accordingly (S1330). For example, it may feedback ACK for PDSCH #3 and NACK for PDSCH #1,2,4.

The base station transmits the second DCI (S1340) and retransmits a plurality of data channels, such as PDSCH #1-1, 2-1, and 4-1 (S1350). The second DCI also includes DHPI information. The base station transmits a second DCI scheduling PDSCH #1-1, 2-1, and 4-1, which are retransmissions for PDSCH #1, 2, and 4. At this time, the HARQ process numbers of PDSCH #1-1, 2-1, and 4-1 are discontinuous like 5, 6, and 8.

The value of the HARQ process number field included in the second DCI is 5, the DHPI field is 2 bits, and the value of each bit is given as ‘0’ and ‘l’. Through this, the UE can identify that the starting HARQ process #5 indicated by the HARQ process number field, the following HARQ process #6 are used, and HARQ process #7 is not used. HARQ process #8 can be assumed to be used since there is no explicit DHPI.

The UE can decode the data channels (PDSCH #1-1, 2-1, 4-1) and feed back ACK/NACK accordingly (S1360).

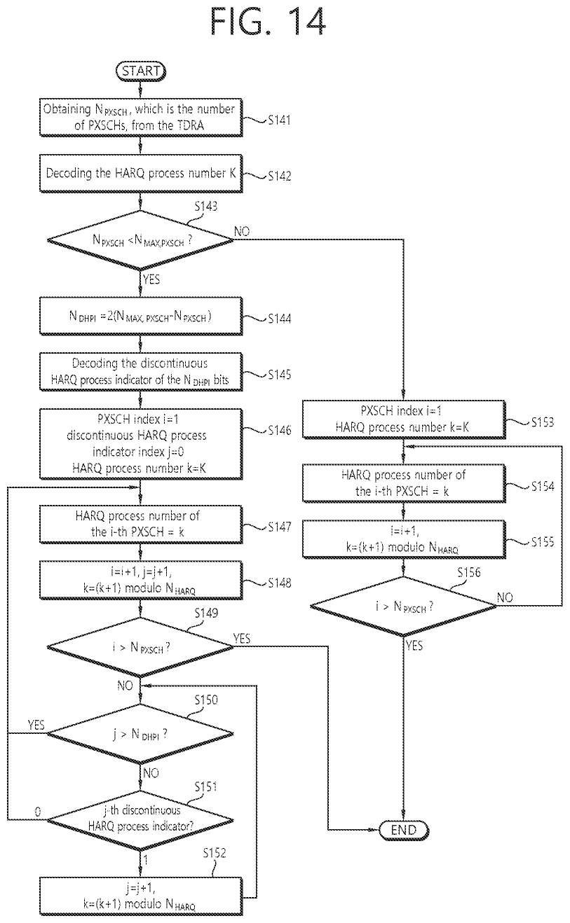

FIG. 14 illustrates a more specific procedure in which the UE processes DCI for discontinuous HARQ process transmission to obtain a HARQ process number for each PXSCH.

Referring to FIG. 14, the UE can obtain N_{PXSCH}, which is the number of PXSCHs, from the TDRA field of DCI (S141). The value K can be decoded/obtained (S142) from the HARQ process number field of the DCI.

The UE compares N_{PXSCH} to the largest number of PXSCHs that can be scheduled (N_{MAX,PXSCH}) (S143), and if N_{MAX,PXSCH} is greater, determines N_{DHPI}, the size of the DHPI field of the DCI, to be 2(N_{MAX,PXSCH}−N_{PXSCH}) (S144), and decodes the discontinuous HARQ process indicator of the N_{DHPI} bits (S145). The PXSCH index i is set to 1, the discontinuous HARQ process indicator index j is set to 0, the HARQ process number k is set to K (S146), and the HARQ process number of the i-th PXSCH is set to k (S147). After that, i is increased by 1 and j is also increased by 1. k is set to ‘(k+1) modulo N_{HARQ}’ (S148). N_{HARQ} is the number of HARQ processes. The UE determines whether i is greater than N_{PXSCH} (S149), and if it is greater, terminates. Otherwise, the UE determines whether j is greater than N_{DHPI} (S150). If j is greater than N_{DHPI}, perform step S147 again: otherwise, determine the value of the j-th discontinuous HARQ process indicator (S151) and: i) if 1, increase j by 1, set k to ‘(k+1) modulo N_{HARQ}’ (S152), and perform step S150 again: ii) if 0), perform step S147 again.

In step S143, if N_{PXSCH} is more than N_{MAX,PXSCH}, the PXSCH index i is set to 1, the HARQ process number k is set to K (S153), and the HARQ process number of the i-th PXSCH is set to k (S154). After that, i is increased by 1, and k is set to ‘(k+1) modulo N_{HARQ}’ (S155). It is determined whether i is greater than N_{PXSCH} (S156), and if it is greater, the process ends. Otherwise, step S154 is performed again.

The present disclosure enables the transmission of discontinuous HARQ processes when transmitting a plurality of physical shared channels (PDSCH or PUSCH) using a single DCI without increasing the size of the DCI. Therefore, data transmission speed and scheduling flexibility can be increased.

Although not limited thereto, the various proposals of the present disclosure described above can be applied to a variety of fields requiring wireless communication/connectivity (e.g., 5G) between devices.

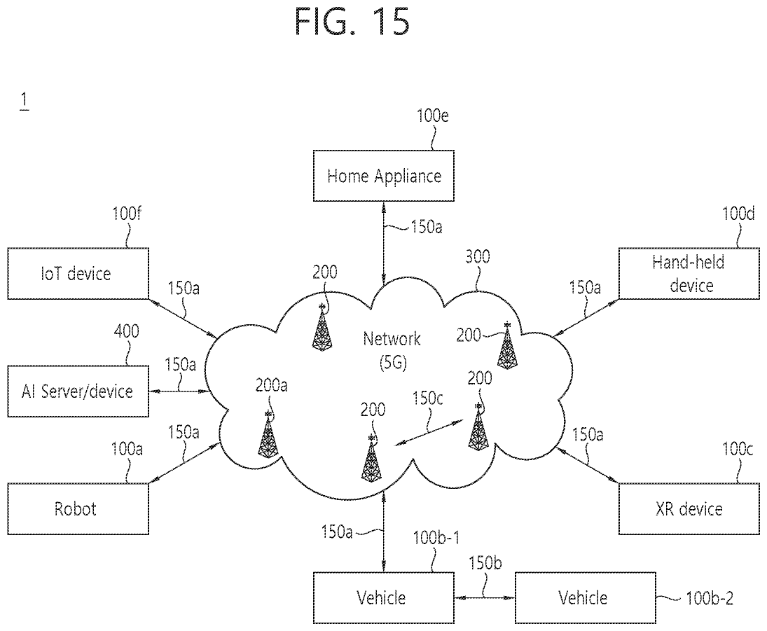

FIG. 15 illustrates a communication system 1 applied to the present disclosure.

Referring to FIG. 15, the communication system 1 applied to the present disclosure includes a wireless device, a base station, and a network. Here, the wireless device refers to a device that performs communication using a wireless access technology (e.g., 5G NR (New RAT), LTE (Long Term Evolution)), and may be referred to as a communication/wireless/5G device. Although not limited thereto, the wireless device may include a robot 100a, a vehicle 100b-1, 100b-2, an extended Reality (XR) device 100c, a hand-held device 100d, and a home appliance 100e.), an Internet of Things (IoT) device 100f, and an AI device/server 400. For example, the vehicle may include a vehicle equipped with a wireless communication function, an autonomous driving vehicle, a vehicle capable of performing inter-vehicle communication, and the like. Here, the vehicle may include an Unmanned Aerial Vehicle (UAV) (e.g., a drone). XR devices include AR (Augmented Reality)/VR (Virtual Reality)/MR (Mixed Reality) devices, and it may be implemented in the form of a Head-Mounted Device (HMD), a Head-Up Display (HUD) provided in a vehicle, a television, a smartphone, a computer, a wearable device, a home appliance, a digital signage, a vehicle, a robot, and the like. The portable device may include a smart phone, a smart pad, a wearable device (e.g., a smart watch, smart glasses), a computer (e.g., a laptop computer), and the like. Home appliances may include a TV, a refrigerator, a washing machine, and the like. The IoT device may include a sensor, a smart meter, and the like. For example, the base station and the network may be implemented as a wireless device, and a specific wireless device 200a may operate as a base station/network node to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). In addition, the IoT device (e.g., a sensor) may perform direct communication with other IoT devices (e.g., sensors) or other wireless devices 100a to 100f.

Wireless communication/connections 150a, 150b may be established between the wireless devices 100a˜100f/BS 200-BS 200/wireless device 100a˜100f. Herein, the wireless communication/connections may be established through various RATs (e.g., 5G NR) such as uplink/downlink communication 150a, sidelink communication 150b (or, D2D communication). The wireless devices and the BSs/the wireless devices may transmit/receive radio signals to/from each other through the wireless communication/connections 150a and 150b. For example, the wireless communication/connections 150a and 150b may transmit/receive signals through various physical channels based on all/part of the process of FIG. 2. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

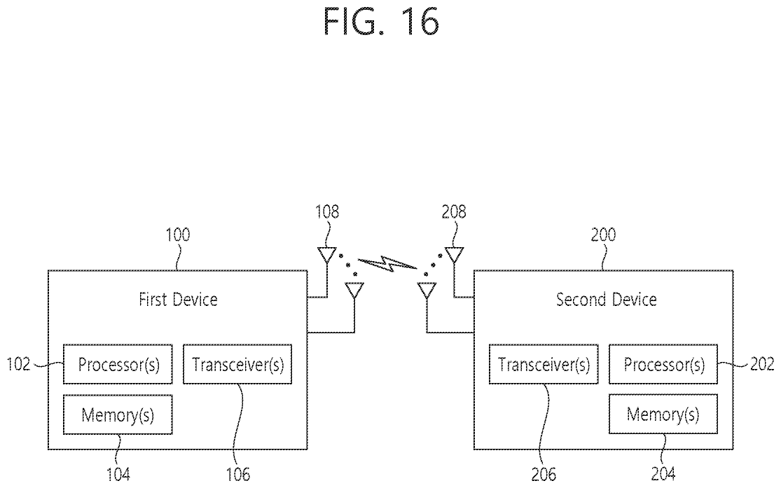

FIG. 16 illustrates a wireless device applicable to the present disclosure.

Referring to FIG. 16, the first wireless device 100 and the second wireless device 200 may transmit and receive wireless signals through various wireless access technologies (e.g., LTE, NR). Here, {first wireless device 100, second wireless device 200} may correspond to {wireless device 100x, base station 200} and/or {wireless device 100x, wireless device 100x} of FIG. 15.

The first wireless device 100 may include one or more processors 102 and one or more memories 104 and additionally further include one or more transceivers 106 and/or one or more antennas 108. The processors 102 may control the memory 104 and/or the transceivers 106 and may be configured to implement the described/suggested functions, procedures and/or methods in above. For example, the processors 102 may process information within the memory 104 to generate first information/signals and then transmit radio signals including the first information/signals through the transceivers 106. In addition, the processor 102 may receive radio signals including second information/signals through the transceiver 106 and then store information obtained by processing the second information/signals in the memory 104. The memory 104 may be connected to the processory 102 and may store a variety of information related to operations of the processor 102. For example, the memory 104 may store software code including commands for performing a part or the entirety of processes controlled by the processor 102 or for performing the described/suggested procedures and/or methods. Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. The transceiver 106 may include a transmitter and/or a receiver. The transceiver 106 may be interchangeably used with a radio frequency (RF) unit. In the present disclosure, the wireless device may represent a communication modem/circuit/chip.

The second wireless device 200 may include one or more processors 202 and one or more memories 204 and additionally further include one or more transceivers 206 and/or one or more antennas 208. The processor 202 may control the memory 204 and/or the transceiver 206 and may be configured to implement the described/suggested functions, procedures and/or methods in above. For example, the processor 202 may process information within the memory 204 to generate third information/signals and then transmit radio signals including the third information/signals through the transceiver 206. In addition, the processor 202 may receive radio signals including fourth information/signals through the transceiver 106 and then store information obtained by processing the fourth information/signals in the memory 204. The memory 204 may be connected to the processor 202 and may store a variety of information related to operations of the processor 202. For example, the memory 204 may store software code including commands for performing a part or the entirety of processes controlled by the processor 202 or for performing the described/suggested procedures and/or methods in above. Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. The transceiver 206 may include a transmitter and/or a receiver. The transceiver 206 may be interchangeably used with an RF unit. In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP. RRC, and SDAP). The one or more processors 102 and 202 may generate one or more Protocol Data Units (PDUs) and/or one or more Service Data Unit (SDUs) according to the functions, procedures, proposals, and/or methods disclosed in this document. The one or more processors 102 and 202 may generate messages, control information, data, or information according to the functions, procedures, proposals, and/or methods disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the functions, procedures, proposals, and/or methods disclosed in this document.

The one or more processors 102 and 202 may be referred to as controllers, microcontrollers, microprocessors, or microcomputers. The one or more processors 102 and 202 may be implemented by hardware, firmware, software, or a combination thereof. For example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The functions, procedures, proposals, and/or methods disclosed in this document may be implemented using firmware or software and the firmware or software may be configured to include the modules, procedures, or functions. Firmware or software configured to perform the functions, procedures, proposals, and/or methods disclosed in this document may be included in the one or more processors 102 and 202 or stored in the one or more memories 104 and 204 so as to be driven by the one or more processors 102 and 202. The functions, procedures, proposals, and/or methods disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. In addition, the one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. In addition, the one or more processors 102 and 202 may perform control so that the one or more transceivers 106 and 206 may receive user data, control information, or radio signals from one or more other devices. In addition, the one or more transceivers 106 and 206 may be connected to the one or more antennas 108 and 208 and the one or more transceivers 106 and 206 may be configured to transmit and receive user data, control information, and/or radio signals/channels, mentioned in the functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

The first device may be, for example, a UE. The first device may include one or more transceivers, one or more memories, and one or more processors operably coupled to the one or more memories. The one or more processors receives one downlink control information (DCI) related with scheduling of a plurality of data channels and receives or transmits at least one data channel of the plurality of data channels based on the DCI. Each of the plurality of data channels is related with a different HARQ process number in ascending order. The DCI comprises information informing the at least one data channel based on a HARQ process number. The information comprises: i) a starting HARQ process number among HARQ process numbers related with the at least one data channel, and ii) a Discontinuous HARQ Process Indicator (DHPI) informing whether each HARQ process number following the starting HARQ process number among the HARQ process numbers is used.

The second device may be, for example, a base station (or a relay station, IAB (integrated access and backhaul) node). The second device may include one or more transceivers, one or more memories, and one or more processors operably coupled to the one or more memories. The second device transmits one downlink control information (DCI) related with scheduling of a plurality of data channels and transmits or receives at least one data channel of the plurality of data channels based on the DCI. Each of the plurality of data channels is related with a different HARQ process number in ascending order. The DCI comprises information informing the at least one data channel based on a HARQ process number. The information comprises: i) a starting HARQ process number among HARQ process numbers related with the at least one data channel, and ii) a Discontinuous HARQ Process Indicator (DHPI) informing whether each HARQ process number following the starting HARQ process number among the HARQ process numbers is used.

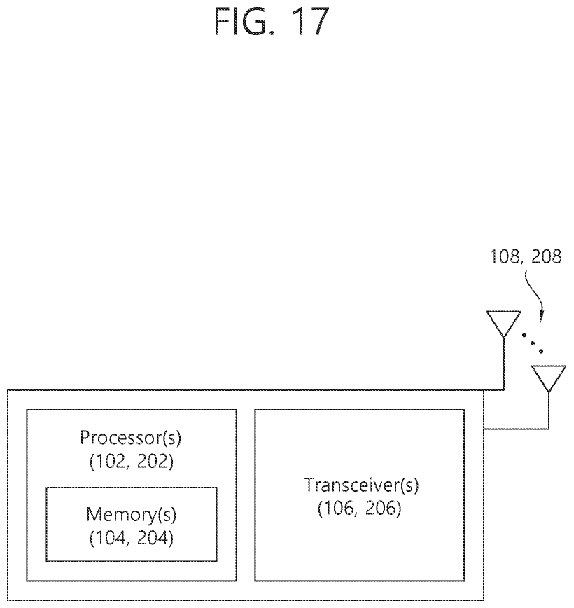

FIG. 17 shows another example of a wireless device that can be applied to this specification.

Referring to FIG. 17, a wireless device may include at least one processor 102, 202, at least one memory 104, 204, at least one transceiver 106, 206, and one or more antennas 108, 208.

A difference between the wireless device example previously described in FIG. 16 and the wireless device example in FIG. 17 is that in FIG. 16, the processor 102, 202 and memory 104, 204 are separate, whereas in the example in FIG. 17, the processor 102, 202 includes memory 104, 204.

The aforementioned method may also be performed by a computer readable medium storing instructions causing the operation to be performed by one or more processors. The operations may include: receiving one downlink control information (DCI) related with scheduling of a plurality of data channels and receiving or transmitting at least one data channel of the plurality of data channels based on the DCI. Each of the plurality of data channels is related with a different HARQ process number in ascending order. The DCI comprises information informing the at least one data channel based on a HARQ process number. The information comprises: i) a starting HARQ process number among HARQ process numbers related with the at least one data channel, and ii) a Discontinuous HARQ Process Indicator (DHPI) informing whether each HARQ process number following the starting HARQ process number among the HARQ process numbers is used.

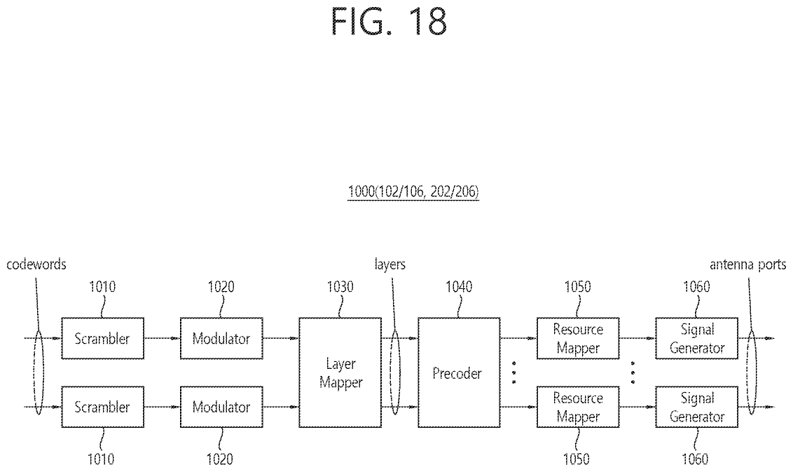

FIG. 18 exemplifies a signal processing circuit for a transmission signal.

Referring to FIG. 18, a signal processing circuit 1000 includes a scrambler 1010, a modulator 1020, a layer mapper 1030, a precoder 1040, a resource mapper 1050, and a signal generator 1060. The operations/functions of FIG. 18 may be performed in the processors 102 and 202 and/or the transceivers 106 and 206 of FIG. 16 but are not limited thereto. The hardware elements of FIG. 18 may be implemented in the processors 102 and 202 and/or the transceivers 106 and 206 of FIG. 16. For example, blocks 1010 to 1060 may be implemented in the processors 102 and 202 of FIG. 16. In addition, blocks 1010 to 1050 may be implemented in the processors 102 and 202 of FIG. 16, and block 1060 may be implemented in the transceivers 106 and 206 of FIG. 16.

A codeword may be converted into a wireless signal through the signal processing circuit 1000 of FIG. 18. Here, the codeword is an encoded bit sequence of an information block. The information block may include a transport block (e.g., a UL-SCH transport block or a DL-SCH transport block). The wireless signal may be transmitted through various physical channels (e.g., PUSCH or PDSCH) of FIG. 2.

Specifically, the codeword may be converted into a scrambled bit sequence by the scrambler 1010. The scramble sequence used for scrambling is generated based on an initialization value, and the initialization value may include ID information of a wireless device. The scrambled bit sequence may be modulated by the modulator 1020 into a modulation symbol sequence. The modulation scheme may include pi/2-binary phase shift keying (pi/2-BPSK), m-phase shift keying (m-PSK), m-quadrature amplitude modulation (m-QAM), and the like. The complex modulation symbol sequence may be mapped to one or more transport layers by the layer mapper 1030. The modulation symbols of each transport layer may be mapped to the corresponding antenna port(s) by the precoder 1040 (precoding). An output z of the precoder 1040 may be obtained by multiplying an output y of the layer mapper 1030 by an N*M precoding matrix W. Here. N is the number of antenna ports and M is the number of transmission layers. Here, the precoder 1040 may perform precoding after performing transform precoding (e.g., DFT transform) on complex modulation symbols. Also, the precoder 1040 may perform precoding without performing transform precoding.

The resource mapper 1050 may map modulation symbols of each antenna port to a time-frequency resource. The time-frequency resource may include a plurality of symbols (e.g., CP-OFDMA symbols or DFT-s-OFDMA symbols) in a time domain and may include a plurality of subcarriers in a frequency domain. The signal generator 1060 may generate a wireless signal from the mapped modulation symbols, and the generated wireless signal may be transmitted to another device through each antenna. To this end, the signal generator 1060 may include an inverse fast Fourier transform (IFFT) module, a cyclic prefix (CP) inserter, a digital-to-analog converter (DAC), a frequency uplink converter, and the like.

A signal processing process for a received signal in the wireless device may be configured as the reverse of the signal processing process (1010 to 1060) of FIG. 18. For example, a wireless device (e.g., 100 or 200 in FIG. 16) may receive a wireless signal from the outside through an antenna port/transmitter. The received wireless signal may be converted into a baseband signal through a signal restorer. To this end, the signal restorer may include a frequency downlink converter, an analog-to-digital converter (ADC), a CP canceller, and a fast Fourier transform (FFT) module. Thereafter, the baseband signal may be restored into a codeword through a resource de-mapper process, a postcoding process, a demodulation process, and a de-scramble process. The codeword may be restored to an original information block through decoding. Accordingly, a signal processing circuit (not shown) for a received signal may include a signal restorer, a resource demapper, a postcoder, a demodulator, a descrambler, and a decoder.

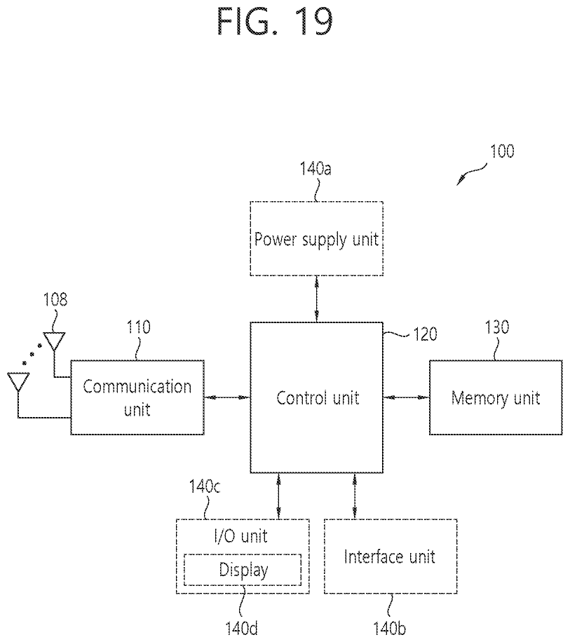

FIG. 19 illustrates a portable device applied to the present disclosure. The portable device may include a smartphone, a smart pad, a wearable device (e.g., smart watch or smart glasses), a portable computer (e.g., a notebook), etc. The portable device may be referred to as a mobile station (MS), a user terminal (UT), a mobile subscriber station (MSS), a subscriber station (SS), an advanced mobile station (AMS), or a wireless terminal (WT).

Referring to FIG. 19, the portable device 100 may include an antenna unit 108, a communication unit 110, a controller 120, a memory unit 130, a power supply unit 140a, an interface unit 140b, and input/output unit 140c. The antenna unit 108 may be configured as a part of the communication unit 110.

The communication unit 110 may transmit and receive signals (e.g., data, control signals, etc.) with other wireless devices and BSs. The controller 120 may perform various operations by controlling components of the portable device 100. The controller 120 may include an application processor (AP). The memory unit 130 may store data/parameters/programs/codes/commands required for driving the portable device 100. Also, the memory unit 130 may store input/output data/information, and the like. The power supply unit 140a supplies power to the portable device 100 and may include a wired/wireless charging circuit, a battery, and the like. The interface unit 140b may support connection between the portable device 100 and other external devices. The interface unit 140b may include various ports (e.g., audio input/output ports or video input/output ports) for connection with external devices. The input/output unit 140c may receive or output image information/signal, audio information/signal, data, and/or information input from a user. The input/output unit 140c may include a camera, a microphone, a user input unit, a display unit 140d, a speaker, and/or a haptic module.

For example, in the case of data communication, the input/output unit 140c acquires information/signals (e.g., touch, text, voice, image, or video) input from the user, and the acquired information/signals may be stored in the memory unit 130. The communication unit 110 may convert information/signals stored in the memory into wireless signals and may directly transmit the converted wireless signals to other wireless devices or to a BS. In addition, after receiving a wireless signal from another wireless device or a BS, the communication unit 110 may restore the received wireless signal to the original information/signal. The restored information/signal may be stored in the memory unit 130 and then output in various forms (e.g., text, voice, image, video, or haptic) through the input/output unit 140c.

The claims described herein may be combined in various ways. For example, a combination of the technical features of the method claims of this specification may be implemented as an apparatus, and a combination of the technical features of the apparatus claims of this specification may be implemented as a method. Further, a combination of technical features of the method claims of this specification and technical features of the apparatus claims of this specification may be implemented as an apparatus, and a combination of technical features of the method claims of this specification and technical features of the apparatus claims of this specification may be implemented as a method. Other implementations are within the scope of the following claims.

1. A method of performing a hybrid automatic repeat and request (HARQ) operation of a user equipment (UE) in a wireless communication system, the method comprising:
receiving one downlink control information (DCI) related with scheduling of a plurality of data channels; and
receiving or transmitting at least one data channel of the plurality of data channels based on the DCI,
wherein each of the plurality of data channels is related with a different HARQ process number in ascending order,
wherein the DCI comprises information informing the at least one data channel based on a HARQ process number,
wherein the information comprises: i) a starting HARQ process number among HARQ process numbers related with the at least one data channel, and ii) a Discontinuous HARQ Process Indicator (DHPI) informing whether each HARQ process number following the starting HARQ process number among the HARQ process numbers is used.

2. The method of claim 1, wherein the UE receives or transmits a data channel related with the starting HARQ process number and a data channel related with a HARQ process number informed to be used by the DHPI.

3. The method of claim 1, wherein the DCI comprises a time domain resource assignment (TDRA) field, new data indicator (NDI) fields, and redundancy version (RV) fields.

4. The method of claim 3, wherein a maximum number of the NDI fields is N_{MAX,PXSCH}, the N_{MAX,PXSCH} being a natural number, and
wherein the maximum number of the RV fields is N_{MAX,PXSCH}, wherein N_{MAX,PXSCH} is a maximum number of data channels that can be scheduled based on a value of the TDRA field.

5. The method of claim 4, wherein when an actual number of the NDI fields included in the DCI is N_{PXSCH}, N_{PXSCH} being a natural number, when an actual number of the RV fields included in the DCI is N_{PXSCH}, and when a number of bits in each RV field is 1 bit, a bit size of a field comprising the DHPI is 2(N_{MAX,PXSCH}−N_{PXSCH}).

6. The method of claim 4, wherein when an actual number of the NDI fields included in the DCI is N_{PXSCH}, N_{PXSCH} being a natural number, when an actual number of the RV fields included in the DCI is N_{PXSCH}, and when a number of bits in each RV field is N_{RV}, N_{RV} being a natural number greater than or equal to 2, a bit size of a field comprising the DHPI is (1+N_{RV}) (N_{MAX,PXSCH}−N_{PXSCH}).

7. A user equipment (UE) performing hybrid automatic repeat and request (HARQ) operation in a wireless communication system, the UE comprising:
at least one transceiver;
at least one memory; and
at least one processor operably coupled to the at least one memory,
wherein the at least one processor is adapted to:
receive one downlink control information (DCI) related with scheduling of a plurality of data channels; and
receive or transmitting at least one data channel of the plurality of data channels based on the DCI,
wherein each of the plurality of data channels is related with a different HARQ process number in ascending order,
wherein the DCI comprises information informing the at least one data channel based on a HARQ process number,
wherein the information comprises: i) a starting HARQ process number among HARQ process numbers related with the at least one data channel, and ii) a Discontinuous HARQ Process Indicator (DHPI) informing whether each HARQ process number following the starting HARQ process number among the HARQ process numbers is used.

8. The UE of claim 7, wherein the UE receives or transmits a data channel related with the starting HARQ process number and a data channel related with a HARQ process number informed to be used by the DHPI.

9. The UE of claim 7, wherein the DCI comprises a time domain resource assignment (TDRA) field, new data indicator (NDI) fields, and redundancy version (RV) fields.

10. The UE of claim 9, wherein a maximum number of the NDI fields is N_{MAX,PXSCH}, the N_{MAX,PXSCH} being a natural number, and
wherein the maximum number of the RV fields is N_{MAX,PXSCH}, wherein N_{MAX,PXSCH} is a maximum number of data channels that can be scheduled based on a value of the TDRA field.

11. The UE of claim 10, wherein when an actual number of the NDI fields included in the DCI is N_{PXSCH}, N_{PXSCH} being a natural number, when an actual number of the RV fields included in the DCI is N_{PXSCH}, and when a number of bits in each RV field is 1 bit, a bit size of a field comprising the DHPI is 2(N_{MAX,PXSCH}−N_{PXSCH}).

12. The UE of claim 10, wherein when an actual number of the NDI fields included in the DCI is N_{PXSCH}, N_{PXSCH} being a natural number, when an actual number of the RV fields included in the DCI is N_{PXSCH}, and when a number of bits in each RV field is N_{RV}, N_{RV} being a natural number greater than or equal to 2, a bit size of a field comprising the DHPI is (1+N_{RV})(N_{MAX,PXSCH}−N_{PXSCH}).

13-14. (canceled)

15. A method of operating a base station in a wireless communication system, the method comprising:
transmitting one downlink control information (DCI) related with scheduling of a plurality of data channels; and
transmitting or receiving at least one data channel of the plurality of data channels based on the DCI,
wherein each of the plurality of data channels is related with a different HARQ process number in ascending order,
wherein the DCI comprises information informing the at least one data channel based on a HARQ process number,
wherein the information comprises: i) a starting HARQ process number among HARQ process numbers related with the at least one data channel, and ii) a Discontinuous HARQ Process Indicator (DHPI) informing whether each HARQ process number following the starting HARQ process number among the HARQ process numbers is used.

16. (canceled)
